(19) United States
(12) Patent Application Publication
(10) Pub. No.: US 2018/0223503 A1
(43) Pub. Date: Aug. 9, 2018

(54) Working Machine

(71) Applicant: Caterpillar SARL, Geneva (CH)

(72) Inventor: Toru Imano, Hyogo (JP)

(73) Assignee: Caterpillar SARL, Geneva (CH)

(21) Appl. No.: 15/749,177

(22) PCT Filed: Aug. 17, 2016
(86) PCT No.: PCT/EP2016/069548

§ 371 Date: Jan. 31, 2018

(30) Foreign Application Priority Data
Aug. 21, 2015 (JP) 2015-163881

(51) Int. Cl. E02F 9/26; B60R 1/00; H04N 5/28

(52) U.S. Cl. CPC E02F 9/26; B60R 2300/101; H04N 5/28; B60R 1/00

(57) ABSTRACT

Provided is a work machine to which a camera device is easily attached while suppressing replacement and addition of components in a machine body and which is capable of switching between securing visibility and protecting a camera main body as needed. A bracket of a camera device and a mount portion at a lower end of a handrail are fastened and attached together on the right side of an upper rotating body with a bolt. A camera main, body is supported on the bracket. The camera main body is arranged to be movable between a first position where at least part of the camera main body protrudes laterally rightward of the upper rotating body and a second position where the camera main body is on the left side of the upper rotating body with respect to the first position.

### TECHNICAL FIELD

The present invention relates to a working machine including a camera device with a camera body monitoring a side area of an upper turning body.

### BACKGROUND ART

Since a recent working machine such as an excavator has a configuration in which a monitoring camera device is attached to a cab opposite area (a right side area) or a rear area of a vehicle not easily viewed from a driver seat inside a cab and a picture obtained from the camera is displayed on a monitor provided inside the cab, an operator can visually recognize a human or a barrier located at the side area or the rear area of the vehicle (for example, see Patent Literatures 1 to 3).

Patent Literature 1 discloses a configuration in which a camera body attachment orientation is changed in such a manner that an attachment hole is formed in a groove shape or an attachment hole, which is used when a camera body at a cap opposite side is attached to a bracket fixed to an upper turning body, is selected.

Further, Patent Literature 2 discloses a configuration in which a camera body protrudes backward at a relatively wide site and the camera body is accommodated in a camera accommodation portion at a narrow site in such a manner that the camera accommodation portion is recessed in a counterweight attached to a rear portion of an upper turning body and the camera body attached to a second bracket is movable in an anteroposterior direction with respect to a first bracket attached to the camera accommodation portion.

Furthermore, Patent Literature 3 discloses a configuration in which a monitoring camera device is fixed at a proper position by using an oiling port portion of an upper surface of a fuel tank provided at a cab opposite side of an upper turning body.

### CITATION LIST

### Patent Literature

[Patent Literature 1] Japanese Unexamined Patent Application, First Publication No. 2014-206021
[Patent Literature 2] Japanese Unexamined Patent Application, First Publication No. 2011-241643
[Patent Literature 3] Japanese Unexamined Patent Application, First Publication No. 2014-47463

### SUMMARY OF INVENTION

### Technical Problem

With regard to a viewing angle at a side area of a vehicle, a dead angle is easily formed at a position close to the vehicle, for example, an end of a crawler at a side area of the vehicle or a rearmost portion of the crawler. In order for a monitoring camera device to capture an image of the position close to the vehicle, there is a need to dispose a camera body so that the camera body protrudes outward in relation to a right end (a side cover) of the vehicle. However, when the camera body is disposed to protrude toward the outside of the vehicle in this way, the camera body can collide with a peripheral barrier or the like during the transportation of a working machine, and thus a countermeasure for preventing damage to the camera body needs to be prepared. Regarding this point, in the configurations of Patent Literatures 1 and 3, a lateral protrusion amount of the camera body with respect to a side end of the vehicle cannot be changed.

Further, when a new monitoring camera device is attached to the existing working machine, it is desirable that the replacement or addition of a component be minimized. Regarding this point, in the configuration of Patent Literature 2, there is a need to replace a component such as an existing counterweight located at a rear side of the vehicle.

This invention is contrived in view of such circumstances and an object of the invention is to provide a working machine capable of having a camera device easily attached thereto while suppressing the replacement or addition of a component of a machine body, and of switching between a viewing angle ensuring state and a camera body protecting state if necessary.

### Solution to Problem

The invention of claim 1 provides a working machine including: a machine body that includes a lower traveling body, an upper turning body which includes a driver seat provided at one side in a width direction and a structure attached to the other side in the width direction as an opposite side to the driver seat by an attachment member and provided to be turnable in an upper portion of the lower traveling body, and a working device which is provided in the upper turning body; and a camera device which is provided in the machine body, wherein the camera device includes a support body which is attached to the other side of the upper turning body in the width direction along with an end of the structure and a camera body which is supported by the support body and monitors the other side of the upper turning body in the width direction, and the camera body is provided to be movable between a first position at which at least a part of the camera body protrudes toward the other side of the upper turning body in the width direction and a second position at which the camera body moves closer toward one side of the upper turning body in the width direction than at the first position.

The invention of claim 2 provides the working machine of claim 1, wherein the camera body is axially supported to be rotatable in the width direction of the upper turning body by the support body.

The invention of claim 3 provides the working machine of claim 1 or 2, wherein the support body is attached to the structure to be movable in the width direction of the upper turning body along with the camera body.

The invention of claim 4 provides the working machine of claim 3, wherein the support body is interposed between the end of the structure and the upper turning body.

The invention of claim 5 provides the working machine of any one of claims 1 to 4, wherein the camera body is attached to the support body to be movable in the width direction of the upper turning body.

### Advantageous Effects of Invention

According to the invention of claim 1, since the support body supporting the camera body is attached to the other side in the width direction of the upper turning body along with the end of the structure by using the attachment member attaching the end of the structure to the other side in the width direction which is the opposite side to one side in the width direction in which the driver seat of the upper turning body is located, it is possible to easily attach the camera device while suppressing the replacement or addition of a component in the machine body. Further, when the camera body is located at the first position at which at least a part of the camera body protrudes laterally at the other side in the width direction of the upper turning body, it is possible to ensure a viewing angle by effectively capturing an image the other side in the width direction of the upper turning body by the camera body. Meanwhile, when the camera body is located at the second position at which the camera body is closer to one side in the width direction of the upper turning body than in the first position in the case where the working machine is transported without using the camera body, it is possible to protect the camera body. Thus, it is possible to switch between a viewing angle ensuring state and a camera body protecting state if necessary.

According to the invention of claim 2, since the camera body is axially supported by the support body to be rotatable in the width direction of the upper turning body, it is possible to easily move the camera body between the first position and the second position by rotating the camera body with respect to the support body.

According to the invention of claim 3, since the support body is attached to the structure to be movable in the width direction of the upper turning body along with the camera body, it is possible to easily move the camera body between the first position and the second position by moving the camera body in the width direction of the upper turning body along with the support body.

According to the invention of claim 4, since the support body is interposed between the end of the structure and the upper turning body, it is possible to easily move the camera body in the width direction of the upper turning body along with the support body by effectively using a space between the end of the structure and the upper turning body.

According to the invention of claim 5, since the camera body is attached to the support body to be movable in the width direction of the upper turning body, it is possible to easily move the camera body between the first position and the second position by moving the camera body in the width direction of the upper turning body with respect to the support body.

### BRIEF DESCRIPTION OF DRAWINGS

FIG. 1 shows a main part of an embodiment of a working machine according to the invention, where FIG. 1(a) is a perspective view showing a main part from one side in a width direction of an upper turning body and FIG. 1(b) is a perspective view showing the main part from the other side in the width direction of the upper turning body.

FIG. 2 shows a camera device of the working machine, where FIG. 2(a) is a perspective view from above and FIG. 2(b) is a perspective view from below.

FIG. 3 shows the main part of a state in which the camera device is attached to the upper turning body through a spacer of the working machine, where FIG. 3(a) is a perspective view showing the main part from one side in the width direction of the upper turning body and FIG. 3(b) is a perspective view showing the main part from the other side in the width direction of the upper turning body.

FIG. 4 is a perspective view showing the inside of a cab of the working machine.

FIG. 5 is a side view showing the working machine.

FIG. 6 shows a viewing angle of a camera body of the camera device of the working machine, where FIG. 6(a) is a side view thereof and FIG. 6(b) is a front view thereof.

FIG. 7 shows a main part of another embodiment of the working machine according to the invention, where FIG. 7(a) is a perspective view showing a state in which the camera body is located at a first position from one side in the width direction of the upper turning body and FIG. 7(b) is a perspective view showing a state in which the camera body is located at a second position from the one side in the width direction of the upper turning body.

FIG. 8(a) is a front view showing the state in which the camera body is located at the first position and FIG. 8(b) is a front view showing the state in which the camera body is located at the second position.

FIG. 9 is a cross-sectional view showing a height adjustment mechanism of the same structure.

FIG. 10 shows still another embodiment of the working machine according to the invention, where FIG. 10(a) is a front view showing a state in which the camera body is located at the first position and FIG. 10(b) is a front view showing a state in which the camera body is located at the second position.

### DESCRIPTION OF EMBODIMENTS

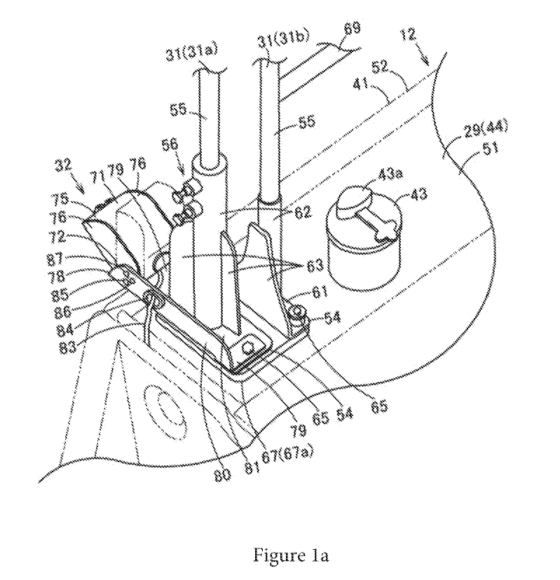

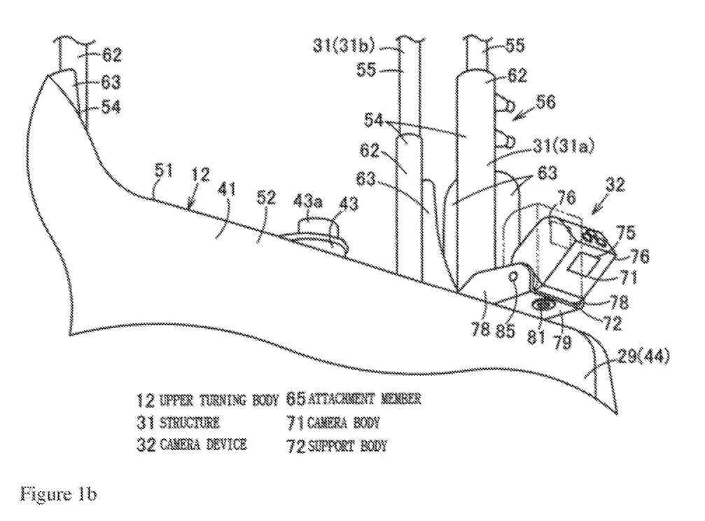

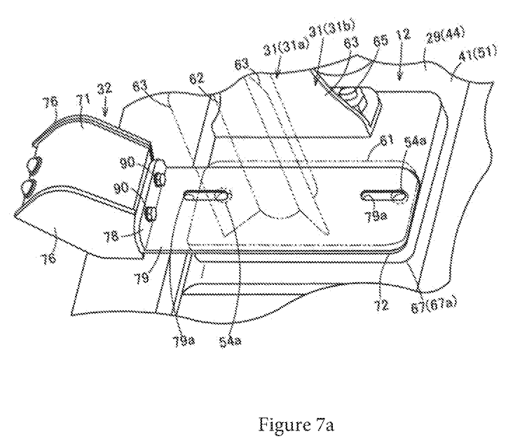

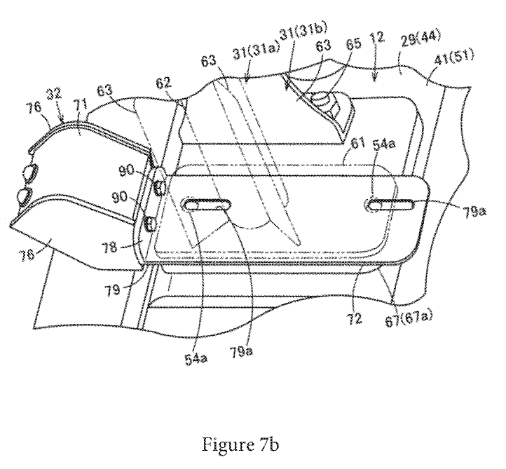

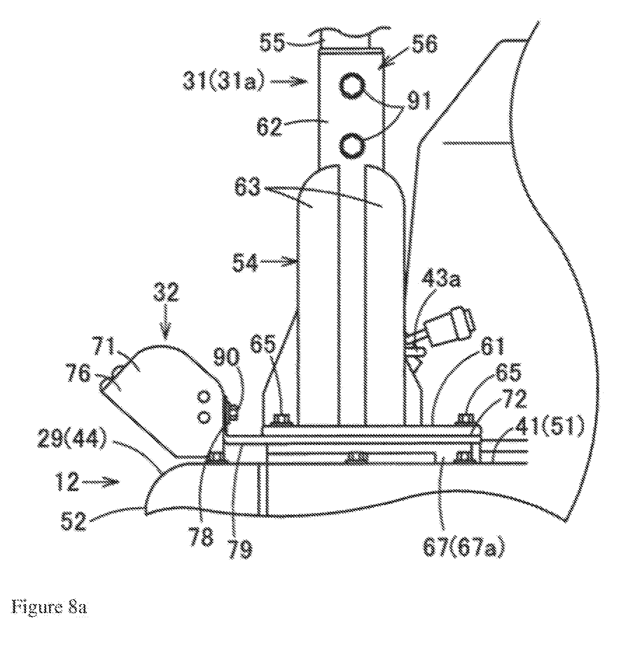

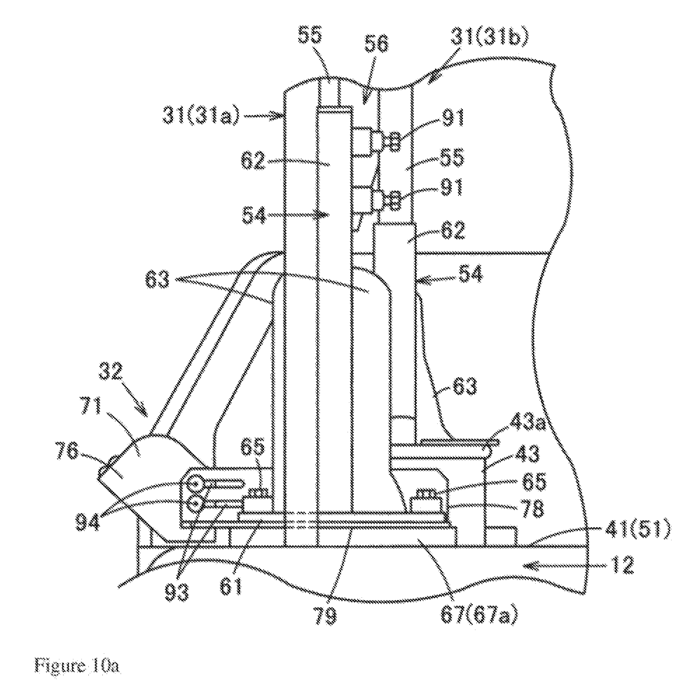

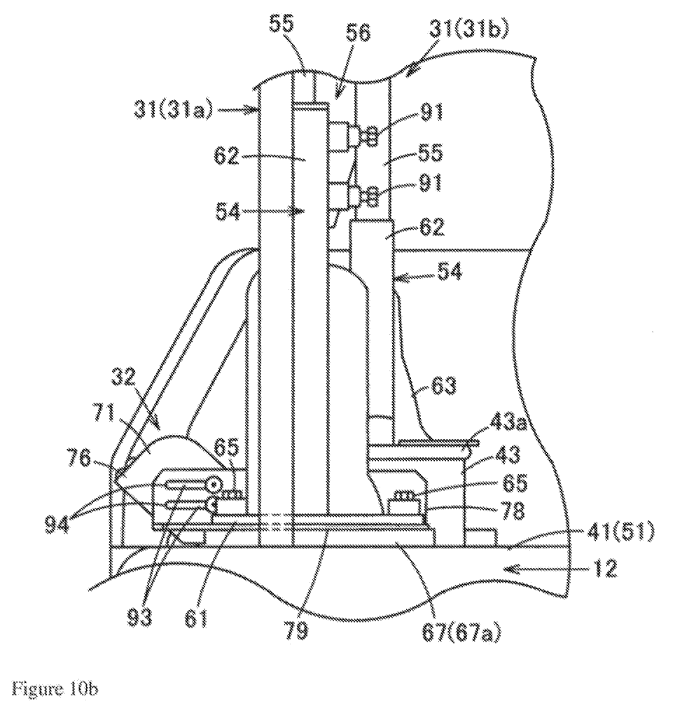

Hereinafter, the invention will be described in detail on the basis of an embodiment shown in FIGS. 1 to 6, another embodiment shown in FIGS. 7 to 9, and still another embodiment shown in FIG. 10.

First, the embodiment shown in FIGS. 1 to 6 will be described.

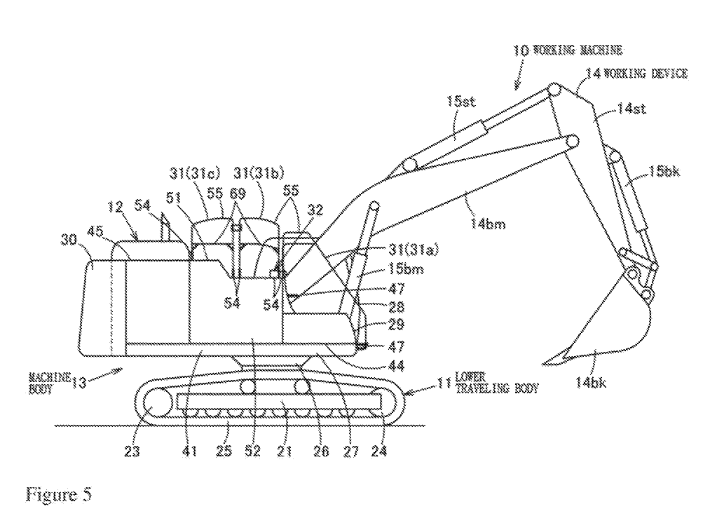

FIG. 5 shows an excavator-type working machine 10, and a working device 14 which moves up and down is mounted on a machine body 13 having an upper turning body 12 provided to be turnable in an upper portion of a lower traveling body 11. Further, the working device 14 has a configuration in which a base end of a boom 14bm is axially supported to be rotatable by the upper turning body 12, a stick 14st is axially supported to be rotatable by a front end of the boom 14bm, a bucket 14bk is axially supported to be rotatable by a front end of the stick 14st, the boom 14bm is rotated by a boom cylinder 15bm, the stick 14st is rotated by a stick cylinder 15st, and the bucket 14bk is rotated by a bucket cylinder 15bk. In the description below, an anteroposterior direction and a horizontal direction (a width direction) are set on the basis of directions viewed by an operator operating the working machine 10.

In the lower traveling body 11, an elongated traveling frame 21 for attaching a crawler thereto is integrated with both sides of a center frame located at a center of a vehicle. Further, a crawler driving unit 23 including a hydraulic traveling motor, a decelerator, and a sprocket is attached to one end of the traveling frame 21. Further, a driven wheel 24 is axially supported to be rotatable by the other end of the traveling frame 21 and an endless crawler 25 is wound around the crawler driving unit 23 and the driven wheel 24 to be rotated along the traveling frame 21. Then, the lower traveling body 11 is configured to rotate the crawler 25 by the driving of the crawler driving unit 23.

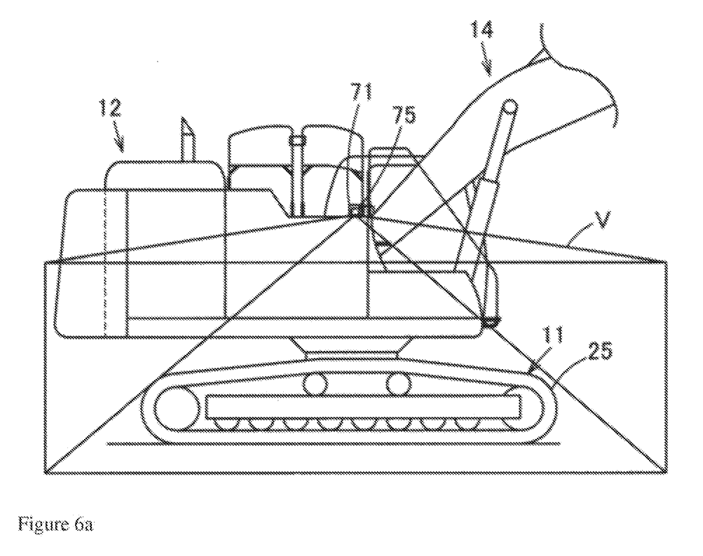

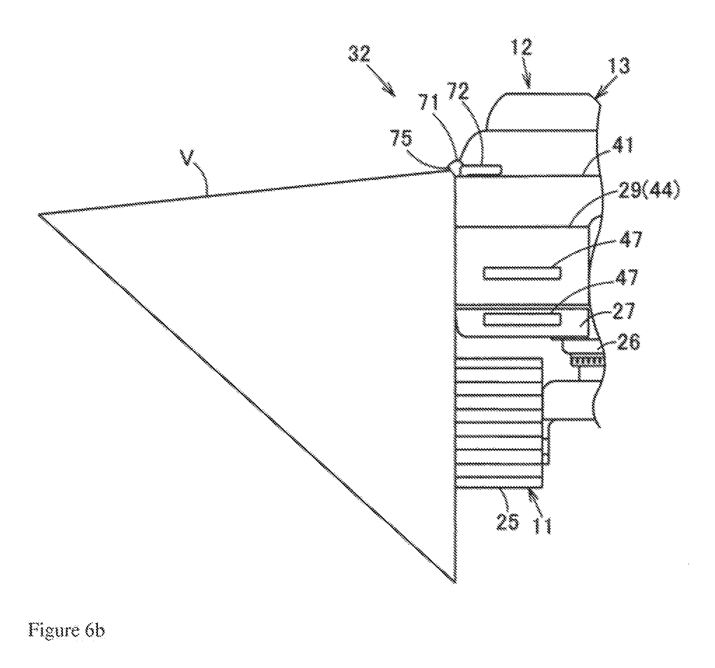

The upper turning body 12 is axially supported to be turnable by the upper portion of the lower traveling body 11 through a turning bearing portion 26 provided at the center frame. In the upper turning body 12, a turning frame 27 which is axially supported by the turning bearing portion 26 is provided at the lower portion of the upper turning body, a cab 28 which protects a working space of an operator is mounted on one side portion in the width direction, for example, a left side portion of the upper turning body, an accommodation portion 29 is provided from the other side portion in the width direction, for example, a right side portion of the upper turning body, to a rear portion thereof, and the working device 14 is disposed at a front center portion of the upper turning body in the horizontal direction. Further, a counterweight 30 is disposed at the rear portion of the upper turning body 12. In other words, the cab 28 is located at the left side of the working device 14, the accommodation portion 29 is located at the right side which is the opposite side of the working device, and the counterweight 30 is disposed behind the accommodation portion 29. Further, in the upper turning body 12, a handrail 31, which is a structure (a pillar-shaped structure), is attached to an upper portion of the accommodation portion 29 at the right side of the cab 28 (the working device 14), and a camera device 32 is integrated with the handrail 31. In addition, the upper turning body 12 is formed with a width dimension equal to or smaller than that of the lower traveling body 11, and both side portions thereof are located at a position at which both of the side portions do not protrude outward from both side portions of the lower traveling body 11 (FIG. 6(b)).

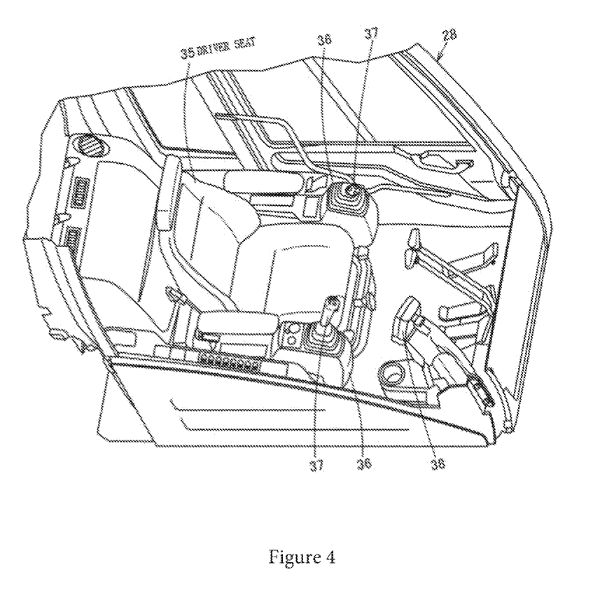

The cab 28 is mounted on the turning frame 27 and is located at a front end of the left side portion of the upper turning body 12 and a right side portion thereof faces a left side portion of the working device 14. That is, the cab 28 and the working device 14 are disposed to be adjacent to each other in the horizontal direction. As shown in FIG. 4, operation levers 37 and 37 operating the working device 14 are respectively provided at upper portions of consoles 36 and 36 respectively provided at left and right portions of a driver seat 35 inside the cab 28. Further, a monitor 38 serving as an input unit and a display unit is disposed in front of the driver seat 35 inside the cab 28.

Returning to FIG. 5, the accommodation portion 29 is provided on the turning frame 27, and a surface thereof is covered by a cover 41. The accommodation portion 29 accommodates articles (not shown) and access from the outside to the articles therein is allowed when a part of the cover 41 is opened or closed or an oiling port 43 (FIG. 1) provided at an upper portion of the cover 41 is used. Examples of the articles include, for example, a tank such as a working oil tank or a fuel tank, a pump such as a hydraulic pump, a valve such as a control valve, a pipe such as a hydraulic pipe or a fuel pipe, and a pump driving engine. Further, the accommodation portion 29 includes a front accommodation portion 44 which is located at a right side area of the cab 28 (the driver seat 35) and the working device 14, that is, a front end of the right side portion of the upper turning body 12, and a rear accommodation portion 45 which is located at the rear portion of the upper turning body 12 over the rear portions of the cab 28 and the front accommodation portion 44.

The front accommodation portion 44 is formed in, for example, a stepped shape which increases in height as it goes from a front side toward a rear side. The front accommodation portion 44 is located at the opposite side to the cab 28 (the driver seat 35 (FIG. 4)) with the working device 14 interposed therebetween. Further, in the front accommodation portion 44, a step 47 which serves as a scaffold for accessing the oiling port 43 (FIG. 1) or the like may be welded to the cover 41 or the turning frame 27 to protrude forward.

The rear accommodation portion 45 is set to be higher than, for example, the front accommodation portion 44. The rear accommodation portion 45 is provided between both the left and right side portions of the upper turning body 12 behind the cab 28, the working device 14, and the front accommodation portion 44.

The cover 41 includes at least an upper surface portion 51 which has a substantially planar shape and forms an upper portion of the upper turning body 12 (the machine body 13) and a side surface portion 52 which forms the right side portion of the upper turning body 12 (the machine body 13). Although not shown in the drawings, the upper surface portion 51 or the side surface portion 52 may be provided with a cover which opens or closes the accommodation portion 29 (the front accommodation portion 44 or the rear accommodation portion 45).

The oiling port 43 shown in FIG. 1 is located at the upper portion of the accommodation portion 29 and protrudes upward from the upper surface portion 51 of the cover 41. In the embodiment, the oiling port 43 is disposed near a rear portion of the front accommodation portion 44. An oiling port cap 43a which opens or closes the oiling port 43 is provided at an upper end of the oiling port 43.

Returning to FIG. 5, the counterweight 30 is used to take a weight balance of the working device 14, is located at a rear portion of the accommodation portion 29 (the rear accommodation portion 45), and is attachable to or detachable from the upper turning body 12.

Then, the handrail 31 is used when an operator climbs onto the accommodation portion 29 (the front accommodation portion 44) in order to check the articles inside the accommodation portion 29 or to perform maintenance or the like, or when the operator accesses the oiling port 43 (FIG. 1). Also, the handrail is used as a safety fence which prevents the operator or the like from falling from the accommodation portion. The handrail 31 is disposed in the anteroposterior direction along an edge of the right side portion (the front accommodation portion 44 of the accommodation portion 29) of the upper turning body 12 and does not protrude rightward in the right side portion of the upper turning body 12. Further, the handrail 31 includes mount portions 54 and 54 which serve as (one and the other) target attachment portions which are ends (lower ends) provided in the upper turning body 12, and a rail body 55 which serves as a structure body (a pillar-shaped structure body) continuous between the mount portions 54 and 54. Additionally, the handrail 31 may be provided with a height adjustment mechanism 56 which adjustably sets a height (an upward protrusion amount) of the upper turning body 12. Further, the handrail 31 can be provided at one or a plurality of positions in response to a size of the machine body 13, but in the embodiment, the plurality of, for example, three, handrails are provided in the anteroposterior direction. That is, in the embodiment, the handrail 31 is set as (first to third) handrails 31a to 31c in a direction from the front side toward the rear side.

The mount portions 54 and 54 are separated from each other in the anteroposterior direction. As shown in FIG. 1(a), each mount portion 54 is integrally provided with, for example, a plate-shaped base portion 61 which is fixed to the upper turning body 12 (the accommodation portion 29) and a tubular (cylindrical) receiving portion 62 which protrudes from the base portion 61 and receives the rail body 55. These mount portions 54 may be further integrally provided with a rib-shaped reinforcement portion 63 which reinforces the base portion 61 and the receiving portion 62 by connecting them to each other. Then, these mount portions 54 are respectively fixed to the upper turning body 12 by bolts 65 which are attachment members. That is, the mount portion 54 is provided with a circular bolt insertion hole (not shown) which is an attachment member insertion hole through which the bolt 65 threaded into a threaded hole (not shown) provided in the upper turning body 12 is inserted, the circular bolt insertion hole being formed so as to penetrate the mount portion in a vertical direction (a thickness direction). For example, the handrail 31a is located in a foremost portion, the front mount portion 54 is attached to a front end of the right side portion of the upper turning body 12 (the turning frame 27 (FIG. 5)) from the front side, and the rear mount portion 54 is attached to an upper portion (the upper surface portion 51 of the cover 41) of the right side portion of the upper turning body 12 from above. Further, in the handrail 31b adjacent to the rear side of the handrail 31a and the handrail 31c adjacent to the rear side of the handrail 31b, the front and rear mount portions 54 and 54 are respectively attached to the upper portion (the upper surface portion 51 of the cover 41) of the right side portion of the upper turning body 12 from above. In addition, the front portion and the upper portion of the upper turning body 12 to be attached with the mount portion 54 may be integrally provided with, for example, a plate-shaped support portion 67 to which the base portion 61 is directly attached.

More specifically, in the handrail 31a, the front mount portion 54 (the base portion 61) is attached to the upper turning body 12 in such a manner that the front mount portion is fixed to a front portion of the turning frame 27 of the upper turning body 12 (FIG. 5) by the bolt 65 threaded thereinto from the front side, and the rear mount portion 54 (the base portion 61) is attached to the upper turning body 12 in such a manner that the rear mount portion is overlapped with the upper portion of the accommodation portion 29 (the front accommodation portion 44) of the upper turning body 12, that is, a support portion 67a provided in the upper surface portion 51 of the cover 41, and the bolt 65 is threaded thereinto from above (along with the camera device 32).

Further, in the handrail 31b, the front mount portion 54 (the base portion 61) is attached to the upper turning body 12 in such a manner that the front mount portion is overlapped with the upper portion of the accommodation portion 29 (the front accommodation portion 44) of the upper turning body 12, that is, the support portion 67 provided in the upper surface portion 51 of the cover 41, which is the rear side of the support portion 67a provided with the rear mount portion 54 of the handrail 31a in the embodiment and the bolt 65 is threaded thereinto from above, and the rear mount portion 54 (the base portion 61) is attached to the upper turning body 12 in such a manner that the rear mount portion is overlapped with the upper portion of the accommodation portion 29 (the front accommodation portion 44) of the upper turning body 12, that is, the support portion 67 provided in the upper surface portion 51 of the cover 41, which is the front side of the support portion 67 separated backward from the support portion 67a in the embodiment and the bolt 65 is threaded thereinto from above.

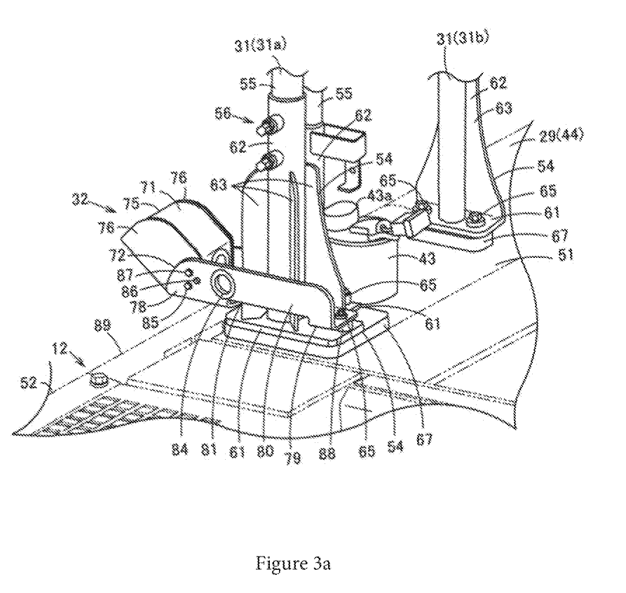

In the handrail 31c shown in FIG. 5, the front mount portion 54 (the base portion 61) is attached to the upper turning body 12 in such a manner that the front mount portion is overlapped with the upper portion of the accommodation portion 29 (the front accommodation portion 44) of the upper turning body 12, that is, the support portion 67 (FIG. 3) provided in the upper surface portion 51 of the cover 41, which is the rear side of the support portion 67 (FIG. 3) provided with the rear mount portion 54 of the handrail 31b in the embodiment and the bolt 65 is threaded thereto from above, and the rear mount portion 54 (the base portion 61) is attached to the upper turning body 12 in such a manner that the rear mount portion is overlapped with the upper portion of the accommodation portion 29 (the rear accommodation portion 45) of the upper turning body 12, that is, the support portion 67 (FIG. 3) provided in the upper surface portion 51 of the cover 41 and the bolt 65 is threaded thereto from above.

The rail body 55 is formed in a slender pipe (a cylindrical) shape and is curved in a convex shape to be continuous between the upper portions of the mount portions 54 and 54. The rail body 55 is separated from the upper turning body 12. Further, a reinforcement rail 69 which is a reinforcement member may be integrally provided in the rail body 55 in the form of a bridge in the anteroposterior direction. In the embodiment, the reinforcement rail 69 is provided in, for example, the handrails 31b and 31c.

The height adjustment mechanism 56 shown in FIGS. 1(a) and 1(b) is used to adjustably set a position of the rail body 55 in the vertical direction with respect to the mount portions 54 and 54 and is basically provided in the handrail 31 provided in the upper portion of the upper turning body 12 along with the camera device 32, that is, the handrail 31a located at the foremost position in the embodiment. The height adjustment mechanism 56 is provided between, for example, both lower ends of the rail body 55 and the receiving portion 62 of each mount portion 54.

Then, the camera device 32 is used to ensure a viewing angle by monitoring a side portion, that is, the right side portion which is opposite to the cab 28 (the driver seat 35) of the working machine 10 (the machine body 13), and forms a dead angle for an operator sitting on the driver seat 35 (FIG. 4) inside the cab 28. The camera device 32 includes a camera body 71 and a bracket 72 which is a support body (a support) supporting the camera body 71. Then, the camera device 32 is attached and fixed to the upper turning body 12 in such a manner that the bracket 72 is fixed to the upper portion (the upper surface portion 51 of the cover 41 (the support portion 67)) of the upper turning body 12 along with any handrail 31, that is, the foremost handrail 31a in the embodiment, from above by the bolt 65.

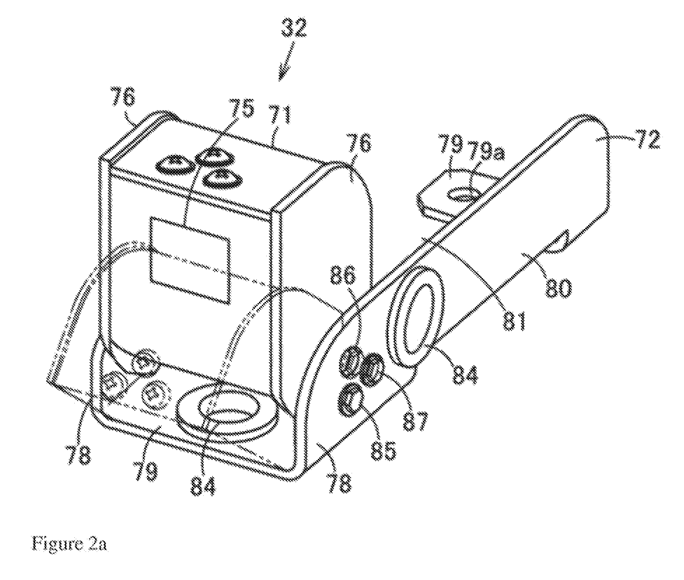

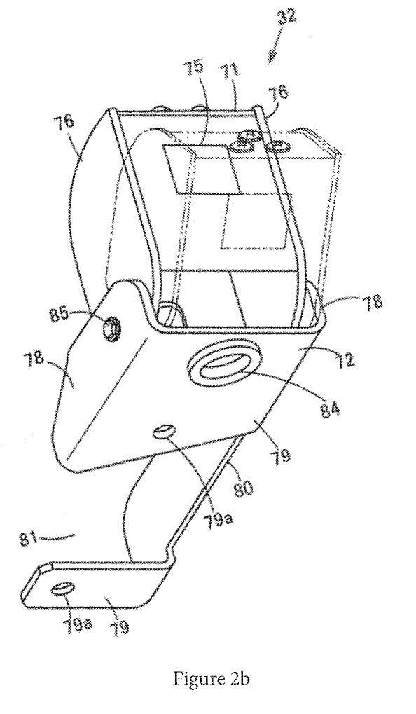

As shown in FIGS. 2(a) and 2(b), the camera body 71 is integrally provided with a camera portion 75 which is a lens portion capturing an image (a picture) of the right side portion of the upper turning body 12 and monitoring the right side portion, and an attachment portion 76 which attaches the camera body 71 to the bracket 72. In the embodiment, the attachment portion 76 is a side plate portion which is integrally formed with both sides of the camera body 71. Then, the camera body 71 is axially supported to be rotatable by the bracket 72 through attachment portions 76 and 76. Further, the image (the picture) captured by the camera body 71 is displayed on the monitor 38 (FIG. 4), and thus can be visually checked by the operator sitting on the driver seat 35 through the monitor 38 (FIG. 4).

As shown in FIG. 1(a), the bracket 72 is attached to an upper right portion of the upper turning body 12 by the bolt 65 along with a lower end of the handrail 31 (the handrail 31a), that is, the mount portion 54 (the base portion 61). The bracket 72 is integrally formed by press-molding, for example, a metal plate. The bracket 72 includes a main support body 78 which supports the camera body 71 and a fixing portion 79 which is fixed to the upper portion of the upper turning body 12 by the bolt 65. The number or the shapes of the main support body 78 and the fixing portion 79 may be arbitrarily set as long as the main support body can support the camera body 71 and the fixing portion 79 can attach the camera body 71 to the upper turning body 12. However, for example, in the embodiment, as shown in FIGS. 2(a) and 2(b), the main support body 78 is located at both sides of the camera body 71, main support bodies 78 and 78 are connected by one fixing portion 79, and the other fixing portion 79 is connected to a front end of an extending portion 80 extending from one main support body 78. Thus, the main support bodies 78 and 78 are separated from each other to be located at both sides of the camera body 71 and the fixing portions 79 and 79 are separated from each other in directions intersecting (orthogonal to) a direction in which the main support bodies 78 and 78 are separated from each other. As shown in FIG. 1(a), a gap between these fixing portions 79 and 79 is formed as a notched portion 81 which serves as an interference preventing portion which is a space for preventing interference with a part of the mount portion 54 (the receiving portion 62 and the reinforcement portion 63). Then, the bracket 72 is provided with an insertion portion 84 through which a wire 83 derived from the camera body 71 is inserted. An arbitrary number of insertion portions 84 can be provided at an arbitrary position. However, as shown in FIGS. 2(a) and 2(b), for example, the insertion hole is provided to penetrate each of one main support body 78 and one fixing portion 79.

An axial support pin 85 which is an axial support body axially supporting the camera body 71 and the bracket 72 to be rotatable is inserted through each main support body 78. These axial support pins 85 are fixed to the attachment portions 76 of the camera body 71. Further, a fixing hole 86 for fixing the camera body 71 at a rotated position is opened in one main support body 78. In the embodiment, the fixing hole 86 is provided at a plurality of positions, for example, two positions, in a circular-arc shape about the axial support pin 85. However, the fixing hole may be an elongated hole which is formed in a circular-arc shape about the axial support pin 85. Then, when a fixing bolt 87 which is a fixing body is inserted and fixed in the fixing hole 86, the camera body 71 is fixed to the bracket 72 at a predetermined rotation angle.

In the fixing portions 79, one fixing portion 79 connecting the main support bodies 78 is located below the camera body 71 and the other fixing portion 79 is separated from the camera body 71 toward the opposite side to an image capturing direction of the camera portion 75 of the camera body 71. Further, a circular insertion hole 79a through which the bolt 65 (FIG. 1(a)) is inserted is opened in each fixing portion 79.

Next, operations and effects of the embodiment shown in FIGS. 1 to 6 will be described.

When the camera device 32 is attached to the upper turning body 12, the camera body 71 is first axially supported to be rotatable by the bracket 72 through the axial support pin 86, and the bracket 72 having the camera body 71 attached thereto is fixed to the upper turning body 12 along with the handrail 31 by the bolt 65. In the embodiment, the bracket 72 of the camera device 32 is overlapped with the rear mount portion 54 (the base portion 61) of the handrail 31a disposed on the support portion 67a, the insertion hole 79a of the bracket 72 is positioned at the bolt insertion hole of the mount portion 54 positioned at a threaded hole provided in the support portion 67a, the bolt 65 is inserted thereinto from above, and the bolt 65 is threaded into the threaded hole, thereby fastening the mount portion 54 (the base portion 61) and the bracket 72 together. Further, the wire 83 is inserted through the most preferable insertion portion 84, which is selected from a positional relation between the attachment position of the camera device 32 and a connection portion electrically connected to the wire 83, and is electrically connected to the connection portion.

For example, as shown in FIGS. 3(a) and 3(b), a height position of the camera device 32 in the vertical direction can be adjusted by the attachment using a boss-shaped spacer 88 between the bracket 72 (the fixing portion 79 (the insertion hole 79a)) and the mount portion 54 (the base portion 61 (the bolt insertion hole)) of the handrail 31.

As a result, the camera device 32 is attached to the vicinity of the oiling port 43 at the substantial center portion of the upper turning body 12 in the anteroposterior direction while the bracket 72 has a longitudinal direction along the horizontal direction (both lateral directions) with respect to the upper turning body 12 and the camera portion 75 of the camera body 71 is directed rightward with respect to the upper turning body 12. That is, the camera device 32 is fixed to the upper turning body 12 so that the camera body 71 rotates in the horizontal direction which is a width direction of the upper turning body 12 about the axial support pin 86 with respect to the bracket 72.

Then, when the working machine 10 is used to perform various types of work including excavating using the working device 14, the camera body 71 is rotated right (the outward direction of the upper turning body 12) with respect to the bracket 72 toward a first position (a use position) at which the camera body 71 protrudes from the right side of the upper turning body 12 and the fixing bolt 87 is inserted and fastened to one fixing hole 86 at the first position so that the camera body 71 is fixed to the bracket 72. In this state, the camera portion 75 of the camera body 71 protrudes outward from the right side portion of the upper turning body 12 to be inclined rightward and downward and the upper turning body 12 is turned so that the anteroposterior direction substantially matches the longitudinal direction of the lower traveling body 11. At this position (a forward traveling position or a backward traveling position), a truncated pyramid-shaped view (an image capturing range) V which is gradually widened from the camera portion 75 of the camera body 71 is located at a position covering both front and rear ends of the lower traveling body 11 (the crawler 25, FIG. 6(a)) and a right end of the lower traveling body 11 (FIG. 6(b)). For this reason, when an image (a picture) captured by the camera body 71 is displayed on the monitor 38, the right side portion of the working machine 10 which cannot be directly viewed by the operator sitting on the driver seat 35 can be monitored without forming a dead angle. Further, in FIG. 6(b), the handrail 31 is not shown in order to further clarify the description.

Meanwhile, when the camera device 32 is not used, as in the case where the working machine 10 is transported, the camera body 71 of the camera device 32 is rotated left (an inward direction of the upper turning body 12) with respect to the bracket 72 so that the camera body is located at a second position (an accommodation position) at which the camera body 71 does not protrude from the right side portion (the side surface portion 52 of the cover 41) of the upper turning body 12 and a rightward protrusion amount of the camera body 71 from the right side portion (the side surface portion 52 of the cover 41) of the upper turning body 12 is smaller than that of the first position. Then, the fixing bolt 87 is inserted and fastened to the other fixing hole 86 at the second position so that the camera body 71 is fixed to the bracket 72. As a result, interference between the camera body 71 and an external member or structure is prevented.

In this way, since the bracket 72 supporting the camera body 71 is attached to the upper right portion of the upper turning body 12 along with the lower end of the handrail 31 (the handrail 31a) by using the bolt 65 for attaching the mount portion 54 (the base portion 61) as the lower end of the handrail 31 (the handrail 31a) to the right side which is the opposite side to the left side which is one side in which the driver seat 35 (the cab 28) of the upper turning body 12 is located, it is possible to suppress the replacement or addition of a component of the machine body 13. That is, it is possible to easily attach the camera device 32 with a small number of added components. Thus, it is possible to retrofit new components to an existing working machine 10 while minimally changing a design.

Further, when the camera body 71 is located at the first position at which at least a part of the camera body protrudes laterally with respect to the right side of the upper turning body 12, it is possible to ensure a viewing angle by effectively capturing an image of the other side of the upper turning body 12 by the camera body 71. Meanwhile, when the camera body 71 is located at the second position at which the camera body moves closer to the left side of the upper turning body 12 than at the first position in the case where the working machine 10 is transported without using the camera body 71, it is possible to protect the camera body 71 from interference with an external member or structure.

Thus, it is possible to easily switch between ensuring the viewing angle and protecting the camera body 71 if necessary.

Furthermore, when the camera body 71 is axially supported by the bracket 72 to be rotatable in the horizontal direction of the upper turning body 12, the camera body 71 can be easily moved between the first position and the second position while being rotated with respect to the bracket 72.

Further, when the bracket 72 of the camera device 32 is attached to the upper portion of the mount portion 54 (the base portion 61) of the lower end of the handrail 31 (the handrail 31a), an attachment height of the camera device 32 can be easily adjusted by using the spacer 88. For example, as shown in FIGS. 3(a) and 3(b), there is a case in which an opening/closing cover 89, for example, a movable opening/closing assembly structure, exists at a portion located below the camera device 32 like the side surface portion 52 of the cover 41 depending on a model, the attachment height of the camera device 32 can be raised by the spacer 88 to be separated upward from the opening/closing cover 89, and thus the camera device 32 rarely hinders the assembly of the opening/closing cover 89.

Furthermore, since the bracket 72 has the interference preventing notched portion 81 provided between the fixing portions 79 and 79, the bracket can be fixed to the upper turning body 12 at a plurality of positions along with the mount portion 54 by the use of the bolt 65 without interference with the mount portion 54 (the receiving portion 62) of the handrail 31, and thus stability can be improved.

Next, another embodiment shown in FIGS. 7 to 9 will be described. Further, the same reference numerals will be given to the same components as the embodiment shown in FIGS. 1 to 6, and the description thereof will be simplified. [0058]

In the embodiment, in the camera device 32, the camera body 71, and the bracket 72 of the embodiment shown in FIGS. 1 to 6 are integrally fixed, and the camera body 71 and the bracket 72 are attached to the handrail 31 (the handrail 31a) to be movable (slidable) in the horizontal direction which is the width direction of the upper turning body 12.

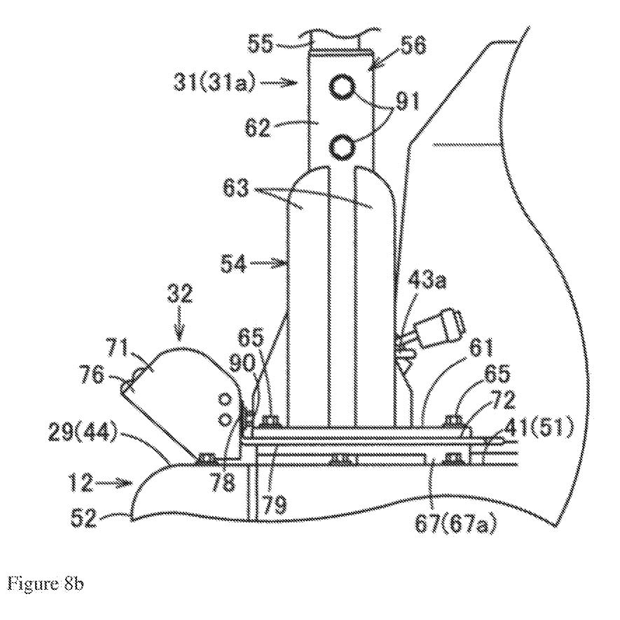

In the bracket 72, for example, the plate-shaped main support body 78 and the plate-shaped fixing portion 79 are continuously formed in an L-shape. For example, in the bracket 72, the main support body 78 which is formed at one end of the longitudinal fixing portion 79 in a longitudinal direction protrudes to be curved upward. Further, the main support body 78 of the bracket 72 is fixed to a rear surface side which is an opposite side to the camera portion 75 of the camera body 71 by a bolt 90. In addition, the insertion hole 79a provided in the fixing portion 79 of the bracket 72 is formed in an elongated hole shape in a horizontal direction. Then, as shown in FIGS. 8(a) and 8(b), the bracket 72 is simultaneously fixed to the upper turning body 12 along with the mount portion 54 (the base portion 61) of a lower end of the handrail 31 (the handrail 31a) by the bolt 65 while the fixing portion 79 is interposed between a lower portion of the mount portion 54 (the base portion 61) of the lower end of the handrail 31 (the handrail 31a) and an upper right upper portion of the upper turning body 12, that is, the upper surface portion 51 of the cover 41, which is the upper portion of the support portion 67 (the support portion 67a) in the embodiment.

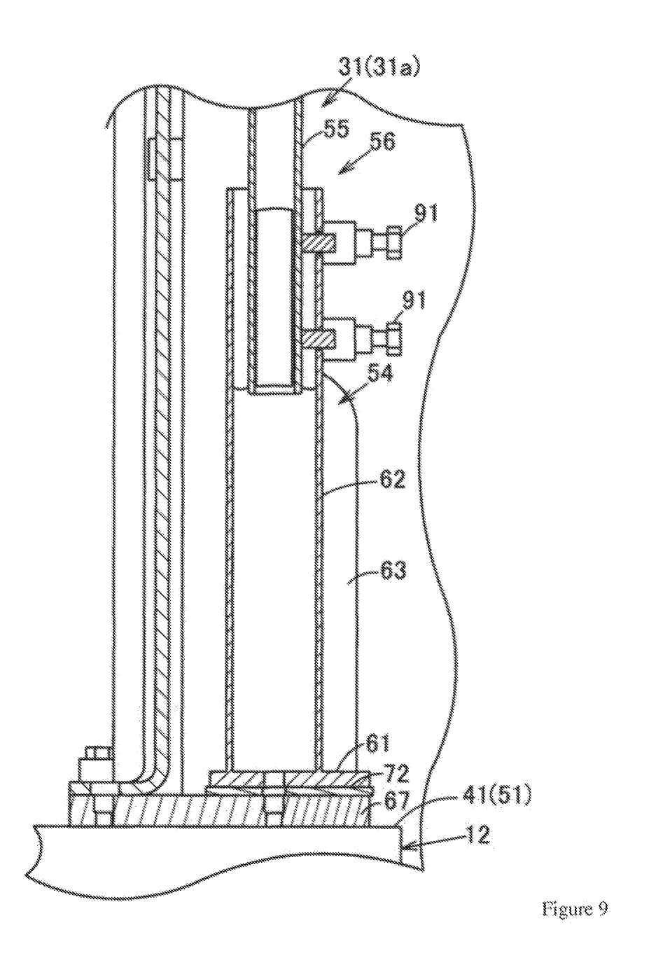

Further, the height adjustment mechanism 56 provided in the handrail 31 (the handrail 31a) shown in FIG. 9 includes height adjustment bolts 91 and 91 which are a pair of fixing members. Then, when the pair of height adjustment bolts 91 and 91 are fastened at a position at which the rail body 55 is slid in the vertical direction with respect to the receiving portion 62 of the mount portion 54 while the height adjustment bolts 91 and 91 are loosened, a height position is fixed.

Then, when the camera device 32 is attached to the upper turning body 12, the camera body 71 is first fixed to the bracket 72 by using bolts 90 and 90, and the bracket 72 having the camera body 71 attached thereto is fixed to the upper turning body 12 along with the handrail 31 by the bolt 65. In the embodiment, the fixing portion 79 of the bracket 72 is overlapped with the support portion 67a, the rear mount portion 54 (the base portion 61) of the handrail 31a is overlapped with the fixing portion 79 of the bracket 72, the elongated hole-shaped insertion hole 79a of the bracket 72 (the fixing portion 79) is positioned at the screw hole provided in the support portion 67a, the insertion hole 79a of the bracket 72 is positioned at the bolt insertion hole 54a which is the circular attachment member insertion hole provided in the mount portion 54, the bolt 65 is inserted into the hole from above, and the bolt 65 is threaded into a threaded hole of the support portion 67a, thereby simultaneously fastening and fixing the mount portion 54 and the bracket 72. As a result, the camera device 32 is attached to the upper turning body 12 while the bracket 72 has a longitudinal direction in the horizontal direction of the upper turning body 12 and the camera portion 75 of the camera body 71 is directed rightward with respect to the upper turning body 12.

Then, when the working machine 10 is used to perform various types of work including excavating by using the working device 14, the bolt 65 is loosened, the camera body 71 is slid left along with the bracket 72, and the bolt 65 (FIG. 8(a)) is fastened, for example, at a position at which a right end which is one end of the insertion hole 79a is aligned to be substantially coaxial with the bolt insertion hole 54a of the mount portion 54 (the base portion 61) (FIG. 7(a)), thereby changing the position of the camera body 71 to the first position (the use position) in which the camera body protrudes from the right side portion of the upper turning body 12.

Meanwhile, when the camera device 32 is not used, as in the case where the working machine 10 is transported, the bolt 65 is loosened, the camera body 71 is slid right along with the bracket 72, and the bolt 65 (FIG. 8(b)) is fastened, for example, at a position at which a left end which is the other end of the insertion hole 79a is aligned to be substantially coaxial with the bolt insertion hole 54a of the mount portion 54 (the base portion 61) (FIG. 7(b)), thereby changing the position of the camera body to the second position (the accommodation position) in which a rightward protrusion amount of the camera body with respect to the right side portion (the side surface portion 52 of the cover 41) of the upper turning body 12 is smaller than that of the first position, and the camera body 71 does not protrude from the right side portion (the side surface portion 52 of the cover 41) of the upper turning body 12.

In this way, since the camera body is movable between the first position at which at least a part of the camera body 71 protrudes laterally with respect to the right side of the upper turning body 12 and the second position at which the camera body is closer to the right side of the upper turning body 12 than at the first position as in the aforementioned embodiment, the same operations and effects as those of the aforementioned embodiment can be obtained.

Further, since the bracket 72 of the camera device 32 is attached to the handrail 31 (the handrail 31a) so as to be movable along with the camera body 71 in the horizontal direction of the upper turning body 12, the camera body 71 can be easily moved between the first position and the second position in such a manner that the camera body 71 is moved in the horizontal direction of the upper turning body 12 along with the bracket 72.

Furthermore, since the bracket 72 is interposed between the mount portion 54 (the base portion 61) which is the lower end of the handrail 31 (the handrail 31a) and the upper turning body 12 (the support portion 67), the camera body 71 can be easily moved in the horizontal direction of the upper turning body 12 along with the bracket 72 by effectively using a space between the mount portion 54 (the base portion 61) of the lower end of the handrail 31 (the handrail 31a) and the upper turning body 12 (the support portion 67).

Further, since the bracket 72 is interposed between the mount portion and the upper portion (the upper portion of the support portion 67 (the support portion 67a) which is the upper surface portion 51 of the cover 41) of the upper turning body 12 (the support portion 67a), a height of the rail body 55 of the handrail 31 (the handrail 31a) is relatively raised by a thickness of the bracket 72, but a height position of the rail body 55 can be easily adjusted by using the height adjustment mechanism 56 shown in FIG. 9. Specifically, when the height adjustment bolts 91 and 91 are loosened, the rail body 55 is slid in the vertical direction with respect to the mount portion 54 (the receiving portion 62), and when the height adjustment bolts 91 and 91 are fastened at an appropriate position, the rail body 55 can be set to a desired height position.

Additionally, in the embodiment shown in FIGS. 7 to 9, for example, when the hole portion of the main support body 78 through which the bolts 90 and 90 fixing the camera body 71 and the bracket 72 are inserted is formed in an elongated hole shape along the vertical direction instead of the height adjustment mechanism 56, the height can be also adjusted in such a manner that the bolts 90 and 90 are loosened, a fixing position of the camera body 71 with respect to the bracket 72 is adjusted in the vertical direction, and the bolts 90 and 90 are fastened.

Next, still another embodiment shown in FIG. 10 will be described. Further, the same reference numerals will be given to the same components as the aforementioned embodiments and the description thereof will be simplified.

In the embodiment, in the camera device 32 shown in FIGS. 7 to 9, the camera body 71 is attached to the bracket 72 to be movable (slidable) in a horizontal direction of the upper turning body 12.

In the bracket 72, for example, the plate-shaped main support body 78 and the plate-shaped fixing portion 79 are continuously formed in an L-shape. For example, in the bracket 72, the main support body 78 which is formed in a longitudinal shape at one end of a longitudinal fixing portion 79 in a width direction protrudes to be curved upward. Further, the main support body 78 of the bracket 72 is formed in a longitudinal shape along a horizontal direction. The main support body 78 is provided with a guide hole 93 as a guide portion formed in an elongated hole shape in the horizontal direction. In the embodiment, the guide hole 93 is provided as a pair of upper and lower guide holes. One attachment portion 76 which is one side of the camera body 71 is fixed to these guide holes 93 by a bolt 94. Thus, when the bolt 94 is loosened, the camera body 71 is movable (slidable) in the horizontal direction of the upper turning body 12 with respect to the bracket 72. Further, the bracket 72 is simultaneously fixed to the upper turning body 12 by the bolt 65 along with the mount portion 54 (the base portion 61) of the lower end of the handrail 31 (the handrail 31a) while the fixing portion 79 is interposed between the lower portion of the mount portion 54 (the base portion 61) of the lower end of the handrail 31 (the handrail 31a) and the upper portion of the upper turning body 12, that is, the upper surface portion 51 of the cover 41, which is the upper portion of the support portion 67 (the support portion 67a) in the embodiment.

Then, when the camera device 32 is attached to the upper turning body 12, the camera body 71 is first fixed to the guide holes 93 and 93 of the main support body 78 of the bracket 72 by using the bolts 94 and 94, and the bracket 72 having the camera body 71 attached thereto is fixed to the upper turning body 12 along with the handrail 31 by the bolt 65. In the embodiment, the fixing portion 79 of the bracket 72 is overlapped with the support portion 67a, the rear mount portion 54 (the base portion 61) of the handrail 31a is overlapped with the fixing portion 79 of the bracket 72, the elongated hole-shaped insertion hole 79a of the bracket 72 (the fixing portion 79) is positioned at the screw hole formed in the support portion 67a, the insertion hole 79a of the bracket 72 is positioned at the bolt insertion hole Ma of the mount portion 54, the bolt 65 is inserted thereto from above, and the bolt 65 is threaded into a threaded hole, thereby simultaneously fastening and fixing the mount portion 54 and the bracket 72. As a result, the camera device 32 is attached to the upper turning body 12 while the bracket 72 has a longitudinal direction in the horizontal direction of the upper turning body 12 and the camera portion 75 of the camera body 71 is directed rightward with respect to the upper turning body 12.

Then, when the working machine 10 is used to perform various types of work including excavating by using the working device 14, the bolts 94 and 94 are loosened, the camera body 71 is slid left with respect to the bracket 72, and the bolts 94 and 94 are fastened, for example, at a position of a right end which is one end of each of the guide holes 93 and 93, thereby changing the position of the camera body 71 to a first position (a use position) in which the camera body protrudes from the right side portion of the upper turning body 12 (FIG. 10(a)).

Meanwhile, when the camera device 32 is not used, as in the case where the working machine 10 is transported, the bolts 94 and 94 are loosened, the camera body 71 is slid right with respect to the bracket 72, and the bolt 65 is fastened, for example, at a position at which a left end which is the other end of each of the guides 93 and 93 is aligned to be substantially coaxial with the bolt insertion hole 54a of the mount portion 54 (the base portion 61) (FIG. 10(b)), thereby changing the position of the camera body to a second position (an accommodation position) in which a rightward protrusion amount of the camera body with respect to the right side portion (the side surface portion 52 of the cover 41) of the upper turning body 12 is smaller than that of the first position, and the camera body 71 does not protrude from the right side portion (the side surface portion 52 of the cover 41) of the upper turning body 12.

In this way, since the camera body is movable between the first position at which at least a part of the camera body 71 protrudes laterally with respect to the right side of the upper turning body 12 and the second position at which the camera body is closer to the right side of the upper turning body 12 than at the first position as in the aforementioned embodiment, the same operations and effects as those of the aforementioned embodiments can be obtained.

Further, since the camera body 71 is attached to the bracket 72 to be movable in the horizontal direction of the upper turning body 12, the camera body 71 can be easily moved between the first position and the second position in such a manner that the camera body 71 is moved in the horizontal direction of the upper turning body 12 with respect to the bracket 72.

Additionally, in the aforementioned embodiments, the handrail 31 has been used as a structure for simultaneously fixing the camera device 32 by the bolt 65, but other arbitrary structures can be used.

Further, at least two of the aforementioned embodiments can be combined arbitrarily.

### INDUSTRIAL APPLICABILITY

The invention is suitable for a monitoring camera device of an excavator-type working machine.

### REFERENCE SIGNS LIST

10: working machine

11: lower traveling body

12: upper turning body

13: machine body

14: working device

31: handrail which is structure

32: camera device

35: driver seat

65: bolt which is attachment member

71: camera body

72: bracket which is support body

1. A working machine comprising;
a machine body that includes a lower traveling body, an upper turning body which includes a driver seat provided at one side in a width direction and a structure attached to the other side in the width direction as an opposite side to the driver seat by an attachment member and provided to be turnable in an upper portion of the lower traveling body, and a working device which is provided in the upper turning body; and
a camera device which is provided in the machine body,
wherein the camera device includes a support body which is attached to the other side of the upper turning body in the width direction along with an end of the structure, and a camera body winch is supported by the, support body and monitors the other side of the upper turning body in the width direction, and
the camera body is provided to be movable between a first position at which at least a part of the camera body protrudes toward the other side of the upper turning body in the width direction and a second position at which the camera body moves closer toward one side of the upper turning body in the width direction than at the first position,

2. The working machine according to claim 1,
wherein the camera body is axially supported to be rotatable in the width direction of the upper turning body by the support body.

3. The working machine according to claim 1,
wherein the support body is attached to the structure to be movable in the width direction of the upper turning body along with the camera body,

4. The working machine according to claim 3,
wherein the support body is interposed between the end of the structure and the upper turning body.

5. The working machine according to claim 1,
wherein the camera body is attached to the support body to be movable in the width direction of the upper turning body.
